(19) United States
(12) Patent Application Publication
(10) Pub. No.: US 2023/0211960 A1
(43) Pub. Date: Jul. 6, 2023

(54) BUFFER SORT

(71) Applicant: Laitram, L.L.C., Harahan, LA (US)

(72) Inventors: Mark Costanzo, New Orleans, LA (US); Matthew L. Fourney, Laurel, MD (US); Bryant G. Ragan, Metairie, LA (US)

(21) Appl. No.: 17/924,838

(22) PCT Filed: Apr. 15, 2021
(86) PCT No.: PCT/US2021/027400

§ 371 Date: Nov. 11, 2022

Related U.S. Application Data
(60) Provisional application No. 63/038,164, filed on Jun. 12, 2020.

(51) Int. Cl. B65G 47/46; B65G 47/64; B07C 5/36; B65G 11/12; B65G 15/42; B65G 37/00; B65G 47/44

(52) U.S. Cl. CPC B65G 47/46; B65G 47/642; B07C 5/36; B65G 11/123; B65G 15/42; B65G 37/005; B65G 47/44; B65G 2201/0285

(57) ABSTRACT

A sorting system having a buffer interposable between a discharge, such as a chute, supplying packages and multiple destination receptacles, such as wheeled bins. The buffer temporarily accumulates packages to ensure correct package delivery to assigned destination receptacles during overflow conditions. The buffer may be realized in various ways that operate in horizontal, vertical, or inclined planes.

### BACKGROUND

The invention relates generally to power-driven conveyors and more particularly to sorting conveyors and buffered multi-destination discharges.

In various industries, such as in package- and parcel-handling, sorting conveyors are used to sort packages into destination receptacles, such as bins, bags, hampers, or totes. Often the packages are discharged from the main sorting conveyor onto chutes each leading to multiple destination receptacles. An overflow of packages on the chutes can lead to packages' being mistakenly sorted to wrong destination receptacles. If the interpackage spacing is not adequate to guarantee accurate sorting, the packages are recirculated or rejected to prevent missorting.

### SUMMARY

One version of a sorting system embodying features of the invention comprises a plurality of receptacles, a discharge supplying packages, and a buffer arranged to receive at least some of the packages from the discharge. Each package is destined for the receptacle assigned it. The buffer has compartments for receiving the packages from the discharge and depositing the packages in the receptacles. A drive mechanism effects relative movement between the compartments and the receptacles so that a package in any compartment is deposited in the assigned receptacle.

Another version of a sorting system comprises a plurality of receptacles movable together, a discharge supplying packages, and a buffer arranged to receive packages from the discharge when the supply of packages from the discharge exceeds a predetermined rate. Each package is destined for its assigned receptacle. The buffer has a plurality of compartments in which the packages are received from the discharge and from which the packages are deposited in the receptacles. A buffer drive is coupled to the buffer to move the compartments relative to the receptacles or a receptacle drive is coupled to the receptacle to move the receptacles relative to the compartments or both so that a package in any compartment is deposited in the assigned receptacle.

### BRIEF DESCRIPTION OF THE DRAWINGS

FIGS. 1A-1I are isometric views of one version of a sorting system embodying features of the invention executing an exemplary sorting sequence.

FIG. 2 is an isometric view of the buffer of FIGS. 1A-1I.

FIGS. 3A-3C are enlarged isometric views of an opening and closing mechanism for the buffer of FIG. 2 showing its operation.

FIG. 4 is an isometric view of a second version of a buffer usable in a sorting system as in FIGS. 1A-1I.

FIG. 5 is an isometric view of a third version of a buffer usable in a sorting system as in FIGS. 1A-1I.

FIG. 6 is an isometric view of a vertical buffer embodying features of the invention for use in a sorting system.

FIG. 7 is a side elevation view of the vertical buffer of FIG. 6.

FIGS. 8A and 8B are isometric views of another version of a buffer embodying features of the invention for use in a sorting system shown in two states.

FIGS. 9A-9C are isometric sequential views of a robotic version of a buffer sorting packages into receptacles.

FIGS. 10A-10I are isometric views of another version of a buffer embodying features of the invention executing a sorting sequence during an overflow.

FIGS. 11A and 11B are enlarged isometric views of a flight actuator for the buffer of FIGS. 10A-10I.

FIG. 12 is a block diagram of a control system for a sorting system as in FIG. 1A, 4, 5, 6, 8A, 9A, or 10A.

### DETAILED DESCRIPTION

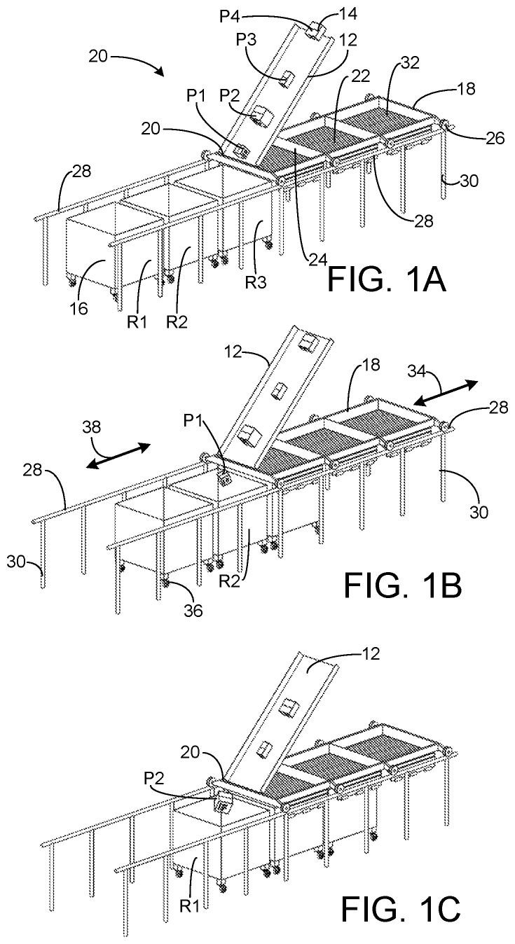

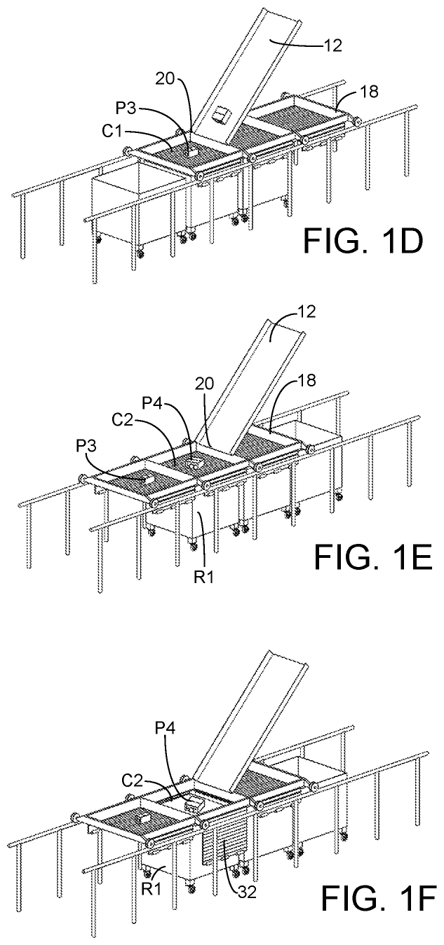

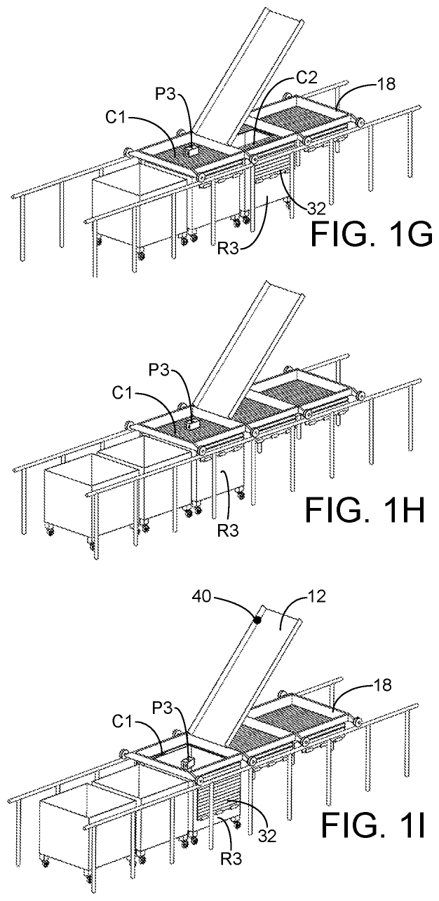

One version of a sorting system embodying features of the invention is shown in FIGS. 1A-1I. The sorting system 20 comprises a main sorting conveyor (not shown) sorting packages off onto multiple discharges. Each discharge is shown in this example as a chute 12 delivering packages 14 by gravity to multiple receptacles 16, such as wheeled bins. A buffer 18 is interposed between the lower end 20 of the discharge chute 12 and the receptacles 16. The buffer has a series of multiple compartments 22 separated by walls 24 extending laterally across the width of the buffer. Wheels 26 at the bottom of the buffer 18 ride in rails 28 under each side. The rails 28 are mounted on support legs 30. Each compartment 22 of the buffer 18 has a door 32 that serves as a floor to support packages 14. The door 32 can be opened to allow a package to fall into an assigned receptacle 16.

As shown in FIG. 1B, the buffer 18 is movable along the rails 28 bidirectionally as indicated by the two-headed arrow 34. Similarly, the train of receptacles 16 is movable on wheels 36 independent of, and in the same opposite directions as, the buffer 18, as indicated by the two-headed arrow 38. The receptacles 36 ride between the two rails 28 and their legs 30. The receptacles 36 are driven as a group by a receptacle drive, which can be any convenient drive mechanism, such as a motorized rack-and-pinion system, a linear actuator, motorized wheels, a bidirectional conveyor belt, or a linear motor. The buffer 18 is driven in the direction of the arrow 34 by a similar buffer drive. The drive mechanism for the buffer drive and the drive mechanism for the receptacle drive are independent mechanisms that drive the buffer and the receptacles independently, but in coordination with each other. Because the receptacles can be moved, the chute 12 can be stationary. Together, the buffer drive and the receptacle drive form a drive mechanism effecting the movement of the compartments 22 in the buffer 18 relative to the receptacles 16.

FIGS. 1A-1I depict an exemplary sequence of operations that show how the buffered sorting system operates during an overflow condition, i.e., when the supply of packages on the chute discharge 12 exceeds a predetermined rate greater than the ability of the receptacle mover to move the receptacles fast enough to keep up with the supply of packages. Packages P1, P2, P3, P4 previously assigned respectively to destination receptacles R2, R1, R3, R1 are shown in FIG. 1A sliding in a single file down the chute 12 by gravity. Before the first package P1, which is assigned to the receptacle R2, reaches the lower end 20 of the chute 12, the receptacle drive moves the train of receptacles R1, R2, R3 so that the assigned receptacle R2 is positioned to receive the package P1 as it falls off the end of the chute 12, as shown in FIG. 1B. The next package P2 is assigned to the receptacle R1. As shown in FIG. 1C, the receptacle drive moved the receptacle R1, assigned to the second package P2, under the lower end 20 of the chute 12 to receive the package P2. Thus, the first two packages P1, P2 bypass the buffer 12. The third package P3, which is assigned to the receptacle R3, trails the second package P2 too closely for the receptacle drive to move the receptacles in time to position the assigned receptacle R2 below the lower end 20 of the chute 12. Instead, the buffer drive moves the buffer 18 so that the package P3 is received in a compartment C1, which is positioned below the lower end 20 of the chute 12, as shown in FIG. 1D. As shown in FIG. 1E, the fourth package P4, closely following the third package P3 and assigned to the receptacle R1, is received in a second compartment C2 moved into the receiving position at the lower end 20 of the chute 12. With the overflow condition on the chute 12 cleared, the receptacle drive moves the receptacles so that the receptacle R1 assigned to the fourth package P4 is positioned beneath the compartment C2, as shown in FIG. 1F, and C2's door 32 is opened to allow the package P4 to drop into its assigned receptacle R1. Next the driven receptacles or the driven buffer 18 or both start to move to position the third package's assigned receptacle R3 under P3's compartment C1, as shown in FIG. 1G. At the same time the door 32 of the previously opened compartment C2 is closed. In FIG. 1H the compartment C1 is shown positioned above P3's assigned receptacle R3. The door 32 of the compartment C1 is then opened by its actuator to drop the third package P3 into its assigned receptacle R3. The actuator then closes the door 32, and the buffer and the receptacles are moved into position to deposit the next package into its assigned receptacle. A position sensor 40 located at a sensing position along or upstream of the discharge chute 12 can be used to detect the package advancing down the chute and gauge the traffic flow. When the flow is great enough, the buffer is used. When the flow is low, the buffer 18 is positioned completely below the chute 12, and packages 14 are deposited directly from the chute into the assigned receptacles without buffering.

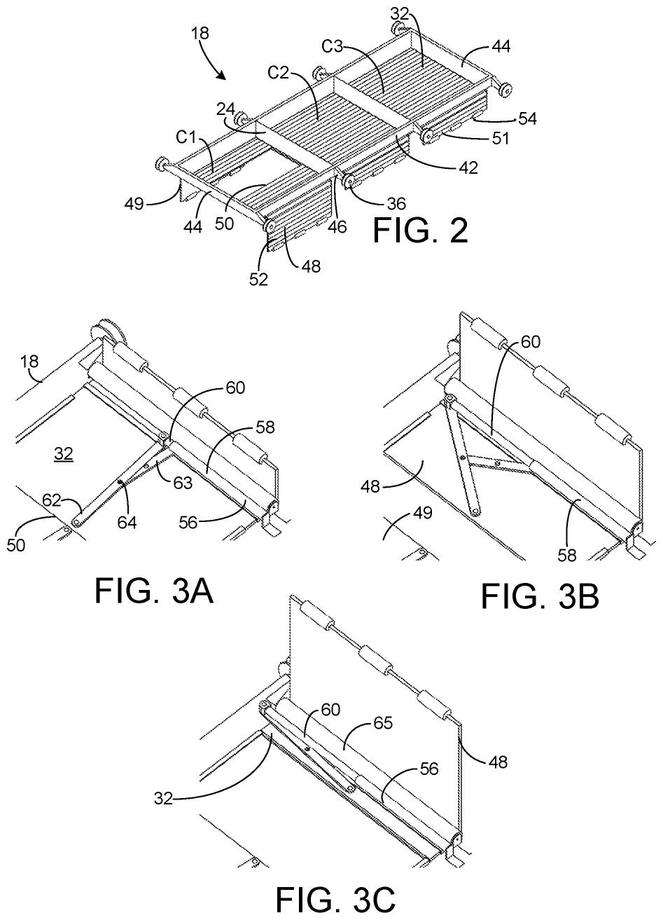

Further details of the buffer 18 of FIGS. 1A-1I are shown in FIGS. 2 and 3A-3C. The buffer 18 shown has three compartments C1-C3, but there could be more. Each compartment C1-C3 is framed by four walls: two longitudinally extending side walls 42 and two laterally extending divider walls 24 or one divider wall and one end wall 44. The wheels 36 are attached to struts 46 extending laterally outward of the side walls 42. The doors 32 comprise a pair of panels 48, 49 whose confronting inner ends 50 meet in the lateral middle of the compartments C1-C3 when the doors are closed. Each panel 48, 49 is made of a series of hinged slats 52 that form an articulating half-door. Outer ends 51 of the panels 48, 49 support weights 54 that provide back tension.

FIGS. 3A-3C illustrate the sequence of opening the door 32 from the underside of the buffer 18. Only one panel 48 is shown, but both panels are operated similarly. A door opener in the form of a linear actuator 56—electric, hydraulic, or pneumatic—has a cylinder 58 attached at one end to the bottom of the buffer 18 at each end of each compartment. The actuator's arm 60 is attached to a Scott Russell linkage. The arm 60 is linearly extensible through the opposite end of the cylinder 58. The outer end of the arm 60 is pivotably connected to one end of a first linkage bar 62 whose opposite end is pivotably connected to the bottom of the panel 48 near the lateral middle of its inner end 50. A shorter second linkage bar 63 is pivotably attached at one end to a pivot point 64 at the middle of the first linkage bar 62. The second linkage bar's opposite end is pivotably attached to the bottom of the buffer 18 between the buffer bottom and the arm end of the cylinder 58. The door 32 is shown closed in FIG. 3A. In FIG. 3B the arm 60 is shown mostly extended from the guides 58 to separate the panel 48 from the other panel 49. In FIG. 3C, the actuator's arm 60 is fully extended to open the door 32 completely. The actuators 56 are operated together on each panel in opening and closing the door 32. An idle roller 65 outward of the actuator 67 provides a guide around which the panel 48 articulates smoothly. Instead of two panels, the door could be made of a single panel, but it would be longer and take more time to open and close.

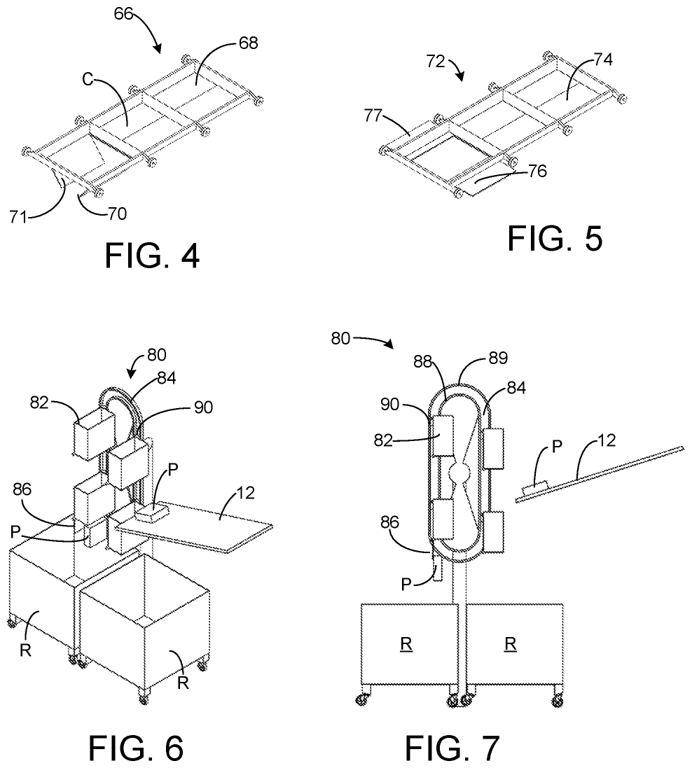

Another version of a buffer is shown in FIG. 4. The buffer 66 has a door 68 made of two flat panels 70, 71 that are attached to the bottom of the buffer along the side of each compartment C. Motorized-hinge door openers (not shown) along the side of each compartment C swing the panels 70, 71 between open and closed positions. FIG. 5 shows a buffer 72 with doors 74 comprising a pair of sliding panels 76, 77 controlled by door-opening actuators (not shown). The two-panel doors 68, 74 of FIGS. 4 and 5 could be replaced by longer single-panel doors, but opening and closing the doors could take longer.

Another version of a sorting system embodying features of the invention is shown in FIGS. 6 and 7. Packages P sliding down a discharge chute 12 and destined for an assigned receptacle R are accumulated in a buffer 80. The buffer 80 comprises a series of buckets 82 serving as buffer compartments movable together around a vertical racetrack 84. Hinged trapdoors 86 forming the floors of the bucket compartments 82 open to drop a package into its assigned receptacle. The racetrack 84 includes two concentric belts—an inner belt 88 and an outer belt 89. Trolleys 90 are pivotably attached to the buckets 82 and affixed at trolley positions between the two belts. The pivotal connection maintains the bucket doors 86 as the floors of the buckets 82 as they travel around the racetrack 84. A buffer drive drives the buckets 82 bidirectionally around the racetrack 84 to position the compartment 82 directly above the receptacle R assigned to the package in the compartment. An actuator (not shown) on each bucket 82 then swings the door 86 open to drop the package P into its destination receptacle R. A receptacle drive includes an actuator or motor (not shown) moving the receptacles R back and forth into position under the buckets 82 on either straightaway of the vertical racetrack 84. Together the racetrack buffer drive and the receptacle drive form a drive mechanism that effects the movement of the buckets 82 in the buffer 80 relative to the receptacles R. And although only two receptacles R are shown, more would be possible.

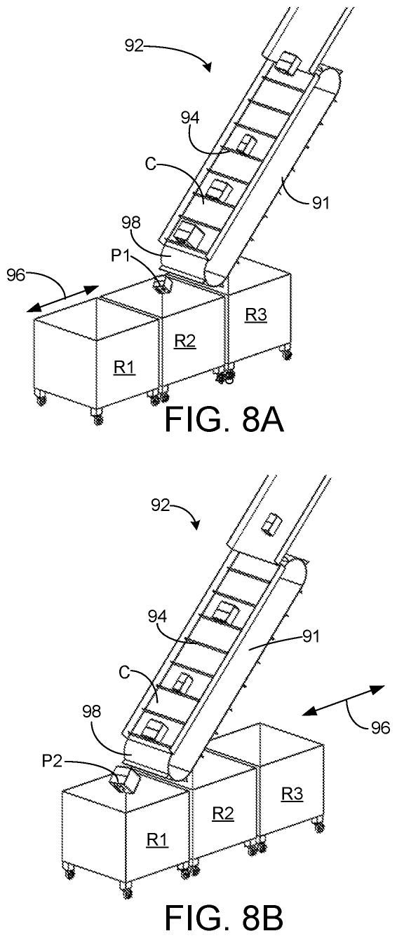

FIGS. 8A and 8B show another version of a sorting system that uses a flighted lowerator conveyor belt 91 as a buffer 92 receiving packages from a discharge upstream. Flights 94 extending across the width of the belt 91 and spaced apart along the length of the belt form compartments C between consecutive flights. The belt is driven conventionally by a buffer drive including, for example, motor-driven pulleys or sprockets. A receptacle drive (not shown) moves the receptacles R as a group back and forth as indicated by the arrow 96 to position the receptacle assigned to the bottommost package on the lowerator belt 91 below the bottom end 98 of the lowerator buffer 92. Together the buffer drive and the receptacle drive form a drive mechanism that effects the movement of the compartments C in the buffer belt 91 relative to the receptacles R. In FIG. 8A the receptacle R2 is positioned to receive the assigned package P1. In FIG. 8B the receptacles have been moved relative to the stationary buffer 92 in position for the assigned receptacle R1 to receive the next package P2. The lowerator belt 91 is driven in stop-and-go fashion so that the lowermost compartment C containing a package is dumped off the end of the lowerator only when the assigned receptacle is positioned to receive the package.

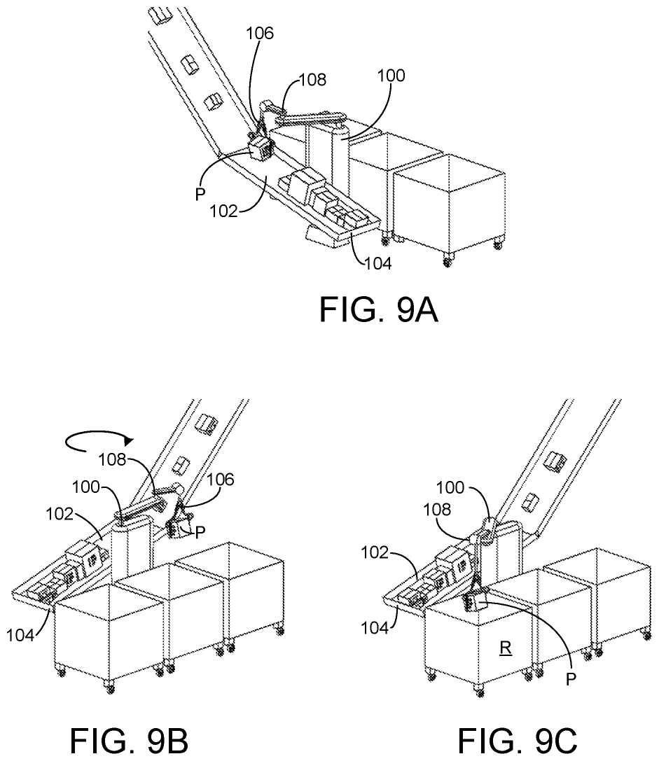

FIGS. 9A-9C show a sorting system in which a robot 100 moves packages accumulated on a table 102 having an end stop 104. A claw 106 extends down from a robotic arm 108 to grab a selected package P. The robot 100 then rotates until the claw 106 and its package P are directly above the assigned receptacle R. Then the robot 100 releases the claw 106, and the package P drops into its assigned receptacle R.

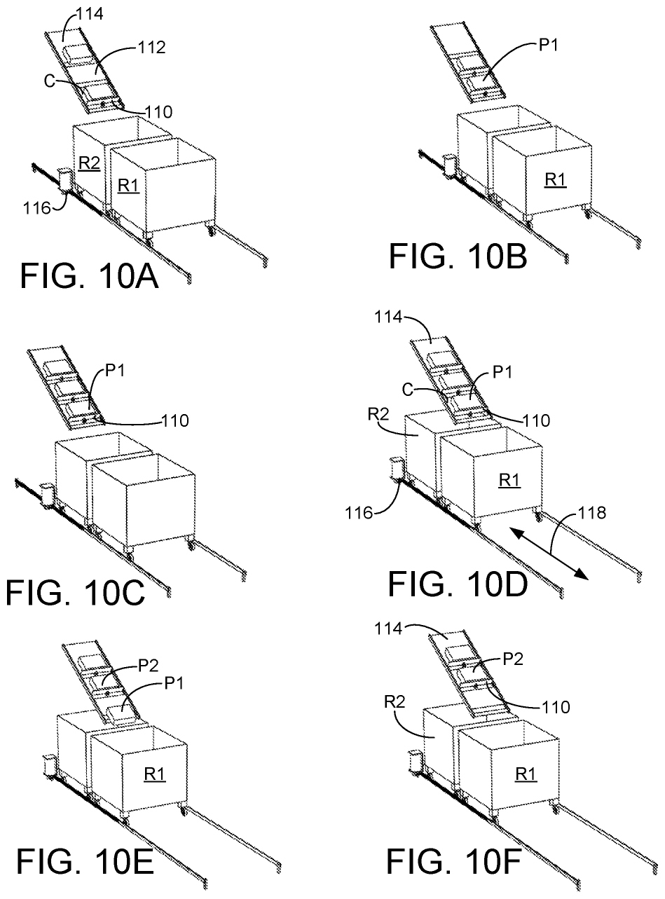

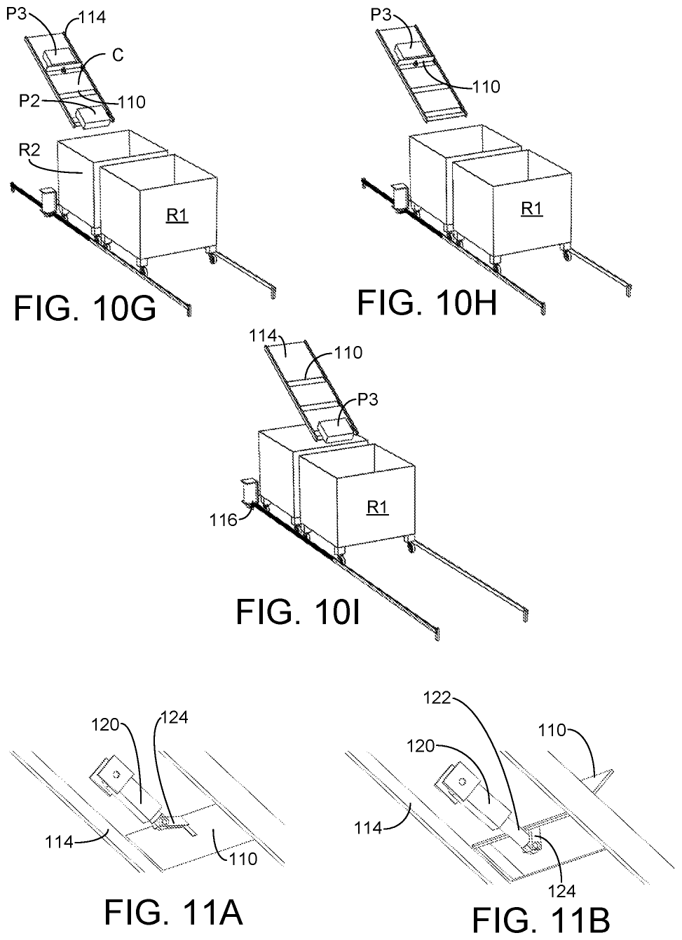

Another version of a sorting system embodying features of the invention is shown in FIGS. 10A-10I. In this version compartments C are formed by pop-up flights 110 forming a portion of the slide face, or floor 112, of a chute buffer 114 receiving packages from a discharge upstream. Receptacles R1, R2 are moved together by a motorized rack-and-pinion receptacle drive 116 that constitutes a drive mechanism effecting the movement of the compartments C in the buffer 114 relative to the receptacles R1, R2. During an overflow condition on the buffer 114, flights 110 are raised to confine the packages to compartments C formed behind the raised flights. When the flights 110 are lowered and form parts of the floor of the chute 114, packages can slide over the lowered flights and down the chute.

FIGS. 10A-10E show the sequence of depositing a package P1 into its assigned receptacle R1. In FIGS. 10A-10D, the package P1 is shown stopped in the lowermost compartment C by the raised flight 110 because its assigned receptacle R1 is not in position under the lower end of the chute buffer 114. In FIG. 10D, the rack-and-pinion receptacle drive 116 moves the receptacles R1, R2 in the direction of the arrow 118 to position the receptacle R1 assigned to the lowermost package P1 at the lower end of the buffer 114 to receive the assigned package P1. As shown in FIG. 10E, the lowermost flight 110 is lowered to allow the package P1 to drop into its assigned destination receptacle R1. FIGS. 10F and 10G show the sequence of depositing a second package P2 into the receptacle R2. The flight 110 at the lower end of P2's compartment remains in a raised blocking position. The receptacle drive moves the receptacles to put assigned receptacle R2 into position under the end of the chute buffer 114. Once the receptacle R2 is in position, the flights below the compartment C are lowered so that the package P2 can slide down the chute 114 unimpeded into the assigned receptacle R2. The third package P3 which is assigned to the receptacle R1, is blocked by the raised flight 110 in FIG. 10H while the other flights ahead of the package remain lowered. When the receptacle drive 116 has moved the assigned receptacle R1 into position at the end of the chute 114 as shown in FIG. 10I, the remaining raised flight 110 is lowered to allow the package P3 to slide down the chute over the closed flights and into its assigned receptacle R1.

As shown in FIGS. 11A and 11B, the pop-up flights 110 are raised and lowered by linear actuators 120 attached at an end to the bottom of the chute 114 and at the other end to the flights via the actuator's arm 122 and a pivotable link 124. When the arm 122 is retracted as in FIG. 11A, the flight 110 is lowered to its non-blocking position. When the actuator's arm 122 is extended as in FIG. 11B, the flight 110 is raised to its blocking position. Instead of using hinged pop-up flights, the chute buffer could be made with translatable pop-up flights that an actuator slides perpendicular to the chute's slide face through a slot in the slide face from a lowered, non-blocking position to a raised, blocking position defining the lower leading end of a compartment.

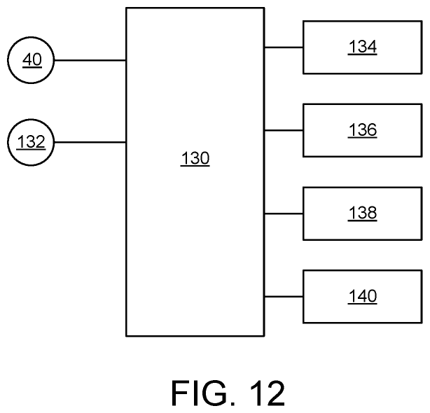

A control system for any of the described sorting systems is shown in FIG. 12. A main controller 130, such as a processor or other programmable device, executes instruction stored in program memory to control the sorting system. The controller 130 collects identifying indicia on each package entering the main sorting conveyor from an indicia-reading sensor 132. From the identifying indicia the controller 130 assigns a destination receptacle to each package. The controller uses position information from position sensors 40 along the length of the sorting system to track each package and divert it to its assigned destination. The controller 130 controls: (a) conveyor drive motors and diverters 134 in the sorting system; (b) the receptacle drive 136; (c) the buffer drive 138; and (d) the buffer actuators 140, e.g., the compartment door openers or the pop-up flight actuators.

Although the invention has been described with respect to a few exemplary versions, other versions are possible. For example, the actuators in any of the versions can be realized as linear actuators, such as pneumatic, hydraulic, or electromagnetic actuators, as rack-and-pinion actuators, or by other equivalent devices capable of translating a slider along slide tracks. And the discharges can be chutes or other kinds of conveyors or conveyor mechanisms delivering packages to the buffers. The term “package” is meant to generically refer to any conveyable objects, such as envelopes, cartons, boxes, and parcels, for example. And other features shown in some of the versions are usable in others of the versions. So, as these few examples suggest, the scope of the claims is not meant to be limited to the exemplary versions disclosed in detail.

What is claimed is:

1. A sorting system comprising:
a plurality of receptacles;
a discharge supplying packages, each destined for the receptacle assigned to the package;
a buffer arranged to receive at least some of the packages from the discharge and having a plurality of compartments for receiving the packages from the discharge and depositing the packages in the receptacles;
a drive mechanism effecting relative movement between the compartments and the receptacles so that a package in any compartment is deposited in the assigned receptacle.

2. The sorting system of claim 1 wherein the discharge supplies the packages not received in the buffer directly to their assigned receptacles.

3. The sorting system of claim 1 wherein drive mechanism comprises at least one of a buffer drive that moves only the plurality of compartments and a receptacle drive that moves only the plurality of receptacles.

4. The sorting system of claim 3 wherein the buffer drive includes a pair of rails and rollers on the buffers riding along the rails.

5. The sorting system of claim 1 wherein the number of receptacles equals the number of compartments.

6. The sorting system of claim 1 wherein the plurality of receptacles are aligned and the plurality of compartments are aligned and parallel to the plurality of aligned receptacles.

7. The sorting system of claim 1 wherein each of the compartments has a door that is selectively closeable in a closed position to support a package and selectively openable in an open position to drop a package into an assigned receptacle.

8. The sorting system of claim 7 wherein the door has two panels that swing between the open and closed positions.

9. The sorting system of claim 7 wherein the door has two panels that slide between the open and closed positions.

10. The sorting system of claim 9 wherein each panel extends from an inner end confronting the inner end of the other panel to an outer end, wherein each panel includes a series of hingedly connected slats and a weight attached to the slat at the outer end.

11. The sorting system of claim 1 wherein the discharge is a chute.

12. The sorting system of claim 1 wherein the buffer comprises a conveyor belt with flights separating the belt into the compartments.

13. The sorting system of claim 1 wherein the buffer comprises a chute having flights selectively movable from a lowered position allowing packages to slide down a floor of the chute and a raised position blocking packages.

14. The sorting system of claim 13 wherein the flights in the lowered position form a portion of the floor of the chute and in the raised position separate two compartments from each other.

15. The sorting system of claim 1 wherein the compartments of the buffer are formed by a series of buckets, each having a selectively openable trapdoor at the bottom and wherein the buffer includes a vertical racetrack around which the series of buckets ride.

16. A sorting system comprising:
a plurality of receptacles movable together;
a discharge supplying packages, each destined for the receptacle assigned to the package;
a buffer arranged to receive packages from the discharge when the supply of packages from the discharge exceeds a predetermined rate, wherein the buffer has a plurality of compartments for receiving the packages from the discharge and depositing the packages in the receptacles;
at least one of a buffer drive coupled to the buffer to move the compartments relative to the receptacles or a receptacle drive coupled to the receptacle to move the receptacles relative to the compartments so that a package in any compartment is deposited in the assigned receptacle.

17. The sorting system of claim 16 wherein the buffer drive includes a pair of rails and rollers on the buffers riding along the rails.

18. The sorting system of claim 16 wherein each of the compartments has an actuator and a door that the actuator selectively closes in a closed position of the door to support a package and that the actuator selectively opens in an open position of the door to drop a package into an assigned receptacle.

19. The sorting system of claim 16 wherein the buffer comprises a conveyor belt with flights separating the belt into the compartments.

20. The sorting system of claim 16 wherein the buffer comprises a chute having flights selectively movable from a lowered position allowing packages to slide down a floor of the chute and a raised position blocking packages.

21. The sorting system of claim 20 wherein the flights in the lowered position form a portion of the floor of the chute and in the raised position separate two compartments from each other.

22. The sorting system of claim 16 wherein the compartments of the buffer are formed by a series of buckets, each having a selectively openable trapdoor at the bottom and wherein the buffer includes a vertical racetrack around which the series of buckets ride.
